(19) United States
(12) Patent Application Publication
(10) Pub. No.: US 2015/0177832 A1
(43) Pub. Date: Jun. 25, 2015

(54) Electronic Device, Display Control Method, and Recording Medium

(71) Applicant: Casio Computer Co., Ltd., Tokyo (JP)

(72) Inventor: Kazunori Kita, Tokyo (JP)

(21) Appl. No.: 14/577,447

(22) Filed: Dec. 19, 2014

(30) Foreign Application Priority Data
Dec. 20, 2013 (JP) 2013-264567

(51) Int. Cl. G06F 3/01; G04G 21/04; G06F 3/14; G06F 3/147

(52) U.S. Cl. CPC G06F 3/013; G06F 3/147; G04G 21/04; G06F 3/14

(57) ABSTRACT

An electronic device includes: a display unit including a display area to display information; an eye position estimation unit configured to estimate at least one of eye positions of a user of the electronic device; a line of sight direction calculation unit configured to calculate a line of sight direction of the user with respect to the electronic device based on the eye position estimated by the eye position estimation unit; and a display control unit configured to change a display position of information on the display area of the display unit based on a change of the line of sight direction calculated by the line of sight direction calculation unit and display the information.

### CROSS-REFERENCE TO RELATED APPLICATIONS

This application is a U.S. Utility Patent Application which claims priority of Japanese Patent Application Number 2013-264567, filed Dec. 20, 2013, which is hereby incorporated herein by reference in its entirety.

### BACKGROUND OF THE INVENTION

The present invention relates to an electronic device, a display control method, and a recording medium.

### DESCRIPTION OF THE RELATED ART

In a related art, there is a known technology in which a display unit configured circularly in part or entirely around a wearing part, such as an arm, is included in an electronic device used by being worn around the arm or the like.

For instance, US2006/0202618 A1 discloses an electronic device including a frame body having a cross section substantially C-shaped, a belt-like display panel disposed along a peripheral surface of the frame body, and a driver IC, wherein the display panel and the driver IC are respectively mounted on flexible substrates different from each other.

However, in the electronic device including a display unit circularly configured, a reference position at the time of executing display cannot be uniquely determined, and therefore, display at an appropriate position can be hardly executed.

### BRIEF SUMMARY OF THE INVENTION

The present invention is made in view of the above-described situation, and is directed to performing more appropriate display in an electronic device attached on a body.

According to an embodiment of the present invention, an electronic device includes: a display unit including a display area to display information; an eye position estimation unit configured to estimate at least one of eye positions of a user of the electronic device; a line of sight direction calculation unit configured to calculate a line of sight direction of the user with respect to the electronic device based on the eye position estimated by the eye position estimation unit; and a display control unit configured to change a display position of information on the display area of the display unit based on a change of the line of sight direction calculated by the line of sight direction calculation unit and display the information.

According to an embodiment of the present invention, a display control method for an electronic device includes steps of: estimating an eye position, in which at least one of eye positions of a user of the electronic device is estimated; calculating a line of sight direction, in which a line of sight direction of the user with respect to the electronic device is calculated based on the eye position estimated by the eye position estimation unit; and controlling display, in which a display position of information on a display area of a display unit is changed based on a change of the line of sight direction calculated by the line of sight direction calculation unit and the information is displayed.

According to an embodiment of the present invention, there is provided a non-transitory computer-readable recording medium storing a program that causes a computer, the computer being configured to control an electronic device including a display unit having a display area to display information, to execute: an eye position estimating function in which at least one of eye positions of a user of the electronic device is estimated; a line of sight direction calculating function in which a line of sight direction of the user with respect to the electronic device is calculated based on the eye position estimated by the eye position estimation unit; and a display control function in which a display position of information on the display area of the display unit is changed based on a change of the line of sight direction calculated by the line of sight direction calculation unit and the information is displayed.

### BRIEF DESCRIPTION OF THE SEVERAL VIEWS OF THE DRAWING

FIGS. 1A and 1B are diagrams illustrating a configuration of a wrist terminal as an embodiment of an electronic device according the present invention, and FIG. 1A is the diagram illustrating an external appearance configuration and FIG. 1B is a block diagram illustrating a hardware configuration;

FIG. 2 is a functional block diagram illustrating a functional configuration to execute display control processing included in functional configurations of the wrist terminal;

FIGS. 3A and 3B are schematic diagrams illustrating arm movement in a user's walking motion, and FIG. 3A is a schematic diagram illustrating the motion viewed from above and FIG. 3B is a schematic diagram illustrating the movement viewed from the side;

FIG. 4 is a schematic diagram illustrating a relation between a user's line of sight direction and a display center position Cp;

FIG. 5 is a flowchart illustrating an exemplary flow of display control processing executed by a wrist terminal having the functional configuration in FIG. 2;

FIG. 6 is a functional block diagram of a wrist terminal according to a second embodiment; and

FIG. 7 is a flowchart illustrating an exemplary flow of display control processing according to the second embodiment.

### DETAILED DESCRIPTION

Embodiments according to the present invention will be described below with reference to the drawings.

### First Embodiment

[Hardware Configuration]

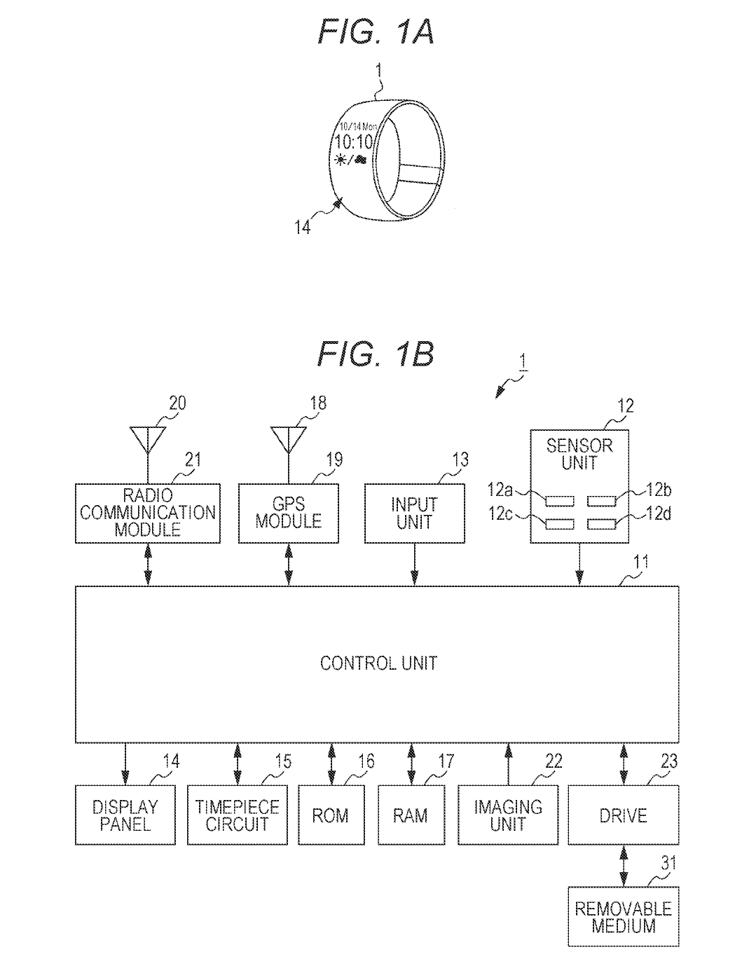

FIGS. 1A and 1B are diagrams illustrating a configuration of a wrist terminal 1 as an embodiment of an electronic device according the present invention, and FIG. 1A is a diagram illustrating an external appearance configuration and FIG. 1B is a block diagram illustrating a hardware configuration.

As illustrated in FIG. 1, the wrist terminal 1 includes a control unit 11, a sensor unit 12, an input unit 13, a display panel 14, a timepiece circuit 15, a ROM (Read Only Memory) 16, a RAM (Read Access Memory) 17, a GPS (Global Positioning System) antenna 18, a GPS module 19, a radio communication antenna 20, a radio communication module 21, an imaging unit 22, and a drive 23.

The control unit 11 includes an arithmetic processing unit such as a CPU (Central Processing Unit), and controls entire operation of the wrist terminal 1. For instance, the control unit 11 executes various kinds of processing in accordance with a program recorded in the ROM 16, such as a program for display control processing (described later).

The sensor unit 12 includes a triaxial acceleration sensor 12a, a magnetic sensor 12b, an atmospheric pressure sensor 12c, and an atmospheric temperature sensor 12d.

The triaxial acceleration sensor 12a detects an acceleration rate in the wrist terminal 1, and outputs information indicating the detected acceleration rate to the control unit 11.

The magnetic sensor 12b detects magnetism in the wrist terminal 1, and outputs information (such as azimuth) indicating the detected magnetism to the control unit 11. According to the present embodiment, the magnetic sensor 12b is configured to detect magnetism with respect to three axes of x-axis, y-axis, and z-axis which are orthogonal to one another. However, the magnetic sensor 12b also may be adopted as a magnetic sensor configured to detect magnetism with respect to two axes out of the x-axis, y-axis, and z-axis.

The atmospheric pressure sensor 12c detects atmospheric pressure in the wrist terminal 1 and outputs information indicating the detected atmospheric pressure to the control unit 11.

The atmospheric temperature sensor 12d detects atmospheric temperature in the wrist terminal 1, and outputs information indicating the detected atmospheric temperature to the control unit 11.

Note that the sensor unit 12 may also include other sensors such as a gyro sensor and a blood pressure sensor in addition to the triaxial acceleration sensor 12a, magnetic sensor 12b, atmospheric pressure sensor 12c, and atmospheric temperature sensor 12d.

The input unit 13 includes, for example, a plurality of buttons provided with a function to execute inputting various kinds of information to the control unit 11 (the buttons mentioned herein include those implemented not only by hardware but also by software).

The display panel 14 displays various kinds of information, such as time, azimuth, or navigation information, in order to move to a destination in accordance with a command from the control unit 11. The display panel 14 according the present embodiment includes a configuration in which a display area is arranged all around an arm (in a range broader than a display area surrounded by a watch bezel in a related art, such as halfway around the arm or more than that) in the case of being worn around the arm of the user. The control unit 11 determines which position in the display panel 14 is to be a center of display (more specifically, a position that the user visually recognizes) by executing the display control processing.

The timepiece circuit 15 generates a time signal from a signal generated by a system clock or an oscillator, and outputs the current time.

The ROM 16 stores information such as a control program to be executed in the control unit 11.

The RAM 17 provides a work area when the control unit 11 executes various kinds of processing.

The GPS antenna 18 receives a radio wave transmitted from a satellite in the GPS and converts the radio wave to an electric signal, and then outputs the converted electric signal (hereinafter, referred to as “GPS signal”) to the GPS module 19.

The GPS module 19 detects the current position (latitude, longitude, and altitude) of the wrist terminal 1 and the current time indicated by the GPS based on the GPS signal input from the GPS antenna 18. Further, the GPS module 19 outputs information indicating the detected current position and current time to the control unit 11.

The radio communication antenna 20 is an antenna capable of receiving a radio wave having a frequency corresponding to radio communication utilized by the radio communication module 21, and includes, for example, a loop antenna or a rod antenna. The radio communication antenna 20 transmits the electric signal of the radio communication input from the radio communication module 21 as an electromagnetic wave, and also converts the received electromagnetic wave to an electric signal and outputs the same the radio communication module 21.

The radio communication module 21 transmits a signal to other devices via the radio communication antenna 20 in accordance with a command from the control unit 11. Further, the radio communication module 21 receives a signal transmitted from other devices, and outputs information indicated by the received signal to the control unit 11.

The imaging unit 22 includes an optical lens section and an image sensor although not illustrated.

The optical lens section includes a lens configured to condense light, such as a focus lens and a zoom lens, in order to photograph an object.

The focus lens is a lens configured to form an image of the object image on a light receiving surface of the image sensor. The zoom lens freely changes a focal length within a fixed range.

The optical lens section may also include a peripheral circuit to adjust setting parameters such as focus, exposure and white balance, depending on necessity.

The image sensor includes a photoelectric conversion element, an AFE (Analog Front End), etc.

The photoelectric conversion element includes, for example, a CMOS (Complementary Metal Oxide Semiconductor) type photoelectric conversion element. The object image is incident from the optical lens section to the photoelectric conversion element. Then, the photoelectric conversion element photoelectrically converts (images) the object image, and accumulates an image signal for a predetermined period, and sequentially supplies the accumulated image signal to the AFE as an analog signal.

The AFE executes various kinds of signal processing such as A/D (Analog/Digital) processing, for the analog image signal. A digital signal is generated by the various kinds of signal processing and then output as an output signal of the imaging unit 22.

Such an output signal from the imaging unit 22 is referred to as “imaged image data” hereinafter. The imaged image data is suitably supplied to the control unit 11, an image processing unit not illustrated, and the like.

The drive 23 is suitably mounted with a removable medium 31 including a magnetic disk, an optical disk, a magnetic optical disk, a semiconductor memory, or the like. In the removable medium 31, various kinds of information such as information related to a user's life log can be stored.

[Functional Configuration]

Next, a functional configuration of the wrist terminal 1 will be described.

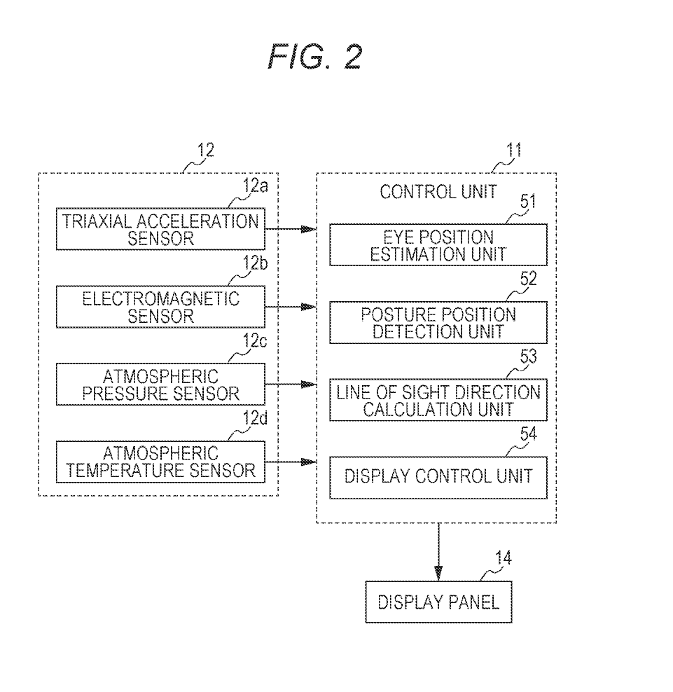

FIG. 2 is a functional block diagram illustrating the functional configuration to execute the display control processing included in the functional configurations of the wrist terminal 1.

The display control processing is a series of processing to determine a user's line of sight direction and set a position oriented to a user's visual point as a center of display in the display area of the wrist terminal 1.

In the case of executing the display control processing, an eye position estimation unit 51, a posture position detection unit 52, a line of sight direction calculation unit 53, and a display control unit 54 are configured to function in the control unit 11.

The eye position estimation unit 51 estimates a user's eye position (a middle point between both eyes) based on a detection result of the sensor unit 12. More specifically, the eye position estimation unit 51 estimates the user's eye position based on arm movement in walking motion of the user.

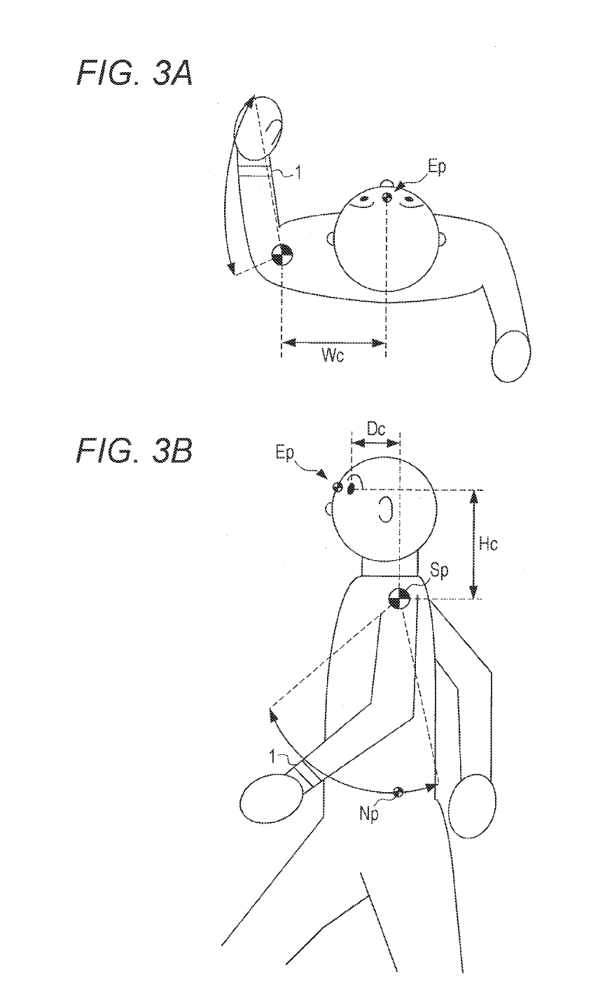

FIGS. 3A and 3B are schematic diagrams illustrating the arm movement in the user's walking motion, and FIG. 3A is a schematic diagram illustrating the motion viewed from above and FIG. 3B is a schematic diagram illustrating the motion viewed from the side.

As illustrated in FIG. 3A, when a human walks, the arms are moved in a reciprocating manner from a side to a front inner side of the body (front of the body) in a manner like drawing an arc. At this point, the eye position estimation unit 51 of the wrist terminal 1 worn around the arm can detect a trajectory of the drawn arc based on the detection result of the sensor unit 12. Subsequently, the eye position estimation unit 51 can detect a shoulder position Sp by calculating a center of the detected arc.

Further, the eye position estimation unit 51 sets, as a body side position Np, a position where a downward acceleration rate of the wrist terminal 1 becomes maximum, and sets a vertical plane passing the body side position Np and the shoulder position Sp as a body trunk plane (hereinafter referred to as “body trunk plane”).

Then, the eye position estimation unit 51 assumes, on the body trunk plane, a normal line passing a position in a distance Wc in a direction inner side of the arc at a position of a height Hc upward from the shoulder position SP, and then estimates, as the eye position, a position in the distance Dc on the normal line in a direction in which the arm draws the larger arc from the body trunk plane.

The height Hc, and the distances Wc, Dc are values statistically acquired and adaptive to a human having a standard body frame.

In this manner, the eye position estimation unit 51 estimates the user's eye position based on arm movement in walking motion of the user.

The posture position detection unit 52 detects a posture and a position of the wrist terminal 1 based on the detection result of the sensor unit 12. Here, the posture is an inclination with respect to a reference plane (horizontal plane) of the wrist terminal 1. The inclination with respect to the reference plane of the wrist terminal 1 is indicated as inclination angles of reference axes (x, y, z axes orthogonal to one another) with respect to the reference plane in the wrist terminal 1. Further, the position is a relative position with respect to a reference point (here, a middle point between both eyes of the user).

The line of sight direction calculation unit 53 calculates a user's line of sight direction with respect to the wrist terminal 1 based on the user's eye position estimated by the eye position estimation unit 51, and the posture of the wrist terminal 1 and the relative position with respect to the eye position detected by the posture position detection unit 52. More specifically, the line of sight direction calculation unit 53 calculates in which direction the user's line of sight direction is located from the viewpoint of the wrist terminal 1 based on the position and posture of the wrist terminal 1. In the following, the position located in the user's line of sight direction is referred to as “display center position Cp” in the wrist terminal 1.

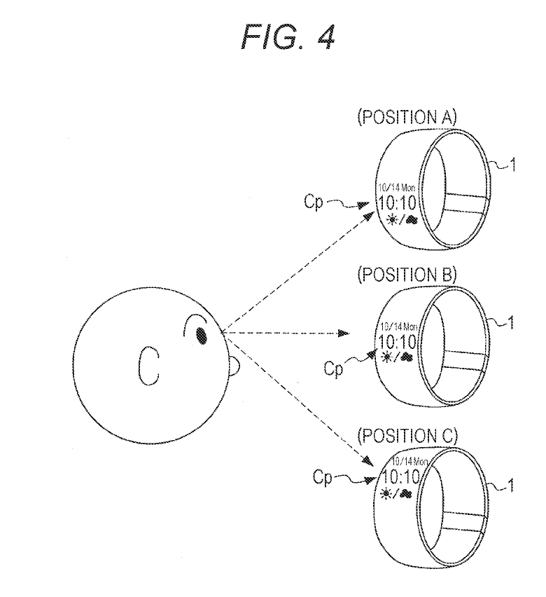

FIG. 4 is a schematic diagram illustrating a relation between the user's line of sight direction and the display center position Cp.

As illustrated in FIG. 4, in the case where the wrist terminal 1 is located at a position A and the user's line of sight is below the wrist terminal 1, the display center position Cp is positioned to be oriented downward from a level of the display area. Further, in the case where the wrist terminal 1 is located at a position B and the user's line of sight is at the same height of the wrist terminal 1, the display center position Cp is positioned to be oriented to the level of the display area. Furthermore, in the case where the wrist terminal 1 is located at a position C and the user's line of sight is above the wrist terminal 1, the display center position Cp is positioned to be oriented upward from the level of the display area.

The display control unit 54 controls various kinds of display in the wrist terminal 1, centering the display center position Cp calculated by the line of sight direction calculation unit 53. For instance, the display control unit 54 displays time and weather, displays a jogging course, and also displays a Web page, centering the display center position Cp. Note that the display control unit 54 may change orientation of the display in accordance with the posture of the wrist terminal 1 detected by the posture position detection unit 52.

Next, operation will be described.

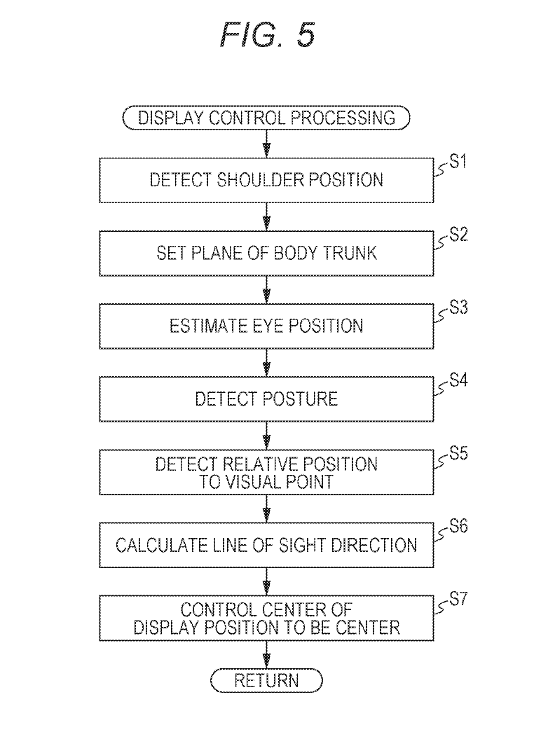

FIG. 5 is a flowchart illustrating an exemplary flow of the display control processing executed by the wrist terminal 1 having the functional configuration in FIG. 2.

The display control processing is started together with power activation of the wrist terminal 1, and repeatedly executed until a command to finish the processing is input.

When the display control processing is started, the eye position estimation unit 51 detects the user's shoulder position Sp based on the detection result of the sensor unit 12 in step S1.

In step S2, the eye position estimation unit 51 sets, as the body trunk plane, a plane passing the detected shoulder position SP and the body side position Np (more specifically, a position where the downward acceleration rate becomes maximum in the detection result of the sensor unit 12).

In step S3, the eye position estimation unit 51 estimates, as the eye position Ep, a predetermined position preliminarily set with respect to the body trunk plane (position in the distance Dc from the body trunk plane on the normal line of the body trunk plane at the height Hc from the shoulder and the position in the distance Wc).

In step S4, the posture position detection unit 52 detects the posture of the wrist terminal 1 with respect to the reference plane based on the detection result of the sensor unit 12.

In step S5, the posture position detection unit 52 detects the relative position of the wrist terminal with respect to the eye position estimated by the eye position estimation unit 51 based on the detection result of the sensor unit 12.

In step S6, the line of sight direction calculation unit 53 calculates the user's line of sight direction (more specifically, display center position Cp) with respect to the wrist terminal 1 based on the user's eye position Ep detected by the eye position estimation unit 51 and the posture and position of the wrist terminal 1 detected by the posture position detection unit 52.

In step S7, the display control unit 54 controls various kinds of display in the wrist terminal 1, centering the display center position Cp.

After step S7, the display control processing is repeated.

Thus, according to the display control processing, the user's eye position Ep is estimated from the user's movement, and the various kinds of display are executed on the display area in the user's line of sight direction in accordance with the posture and position of the wrist terminal 1.

By this, the reference position at the time of executing display can be uniquely defined, and appropriate display can be achieved even in the case where the display area of the display panel 14 is circularly formed.

In other words, more appropriate display can be achieved in the electronic device attached to the body.

As described above, the wrist terminal 1 according to the present embodiment includes the display panel 14, eye position estimation unit 51, line of sight direction calculation unit 53, and display control unit 54.

The display panel 14 includes the display area to display information.

The eye position estimation unit 51 estimates the user's eye position Ep.

The line of sight direction calculation unit 53 calculates the line of sight direction with respect to the device.

The display control unit 54 changes the display position of the information on the display area of the display panel 14 based on the line of sight direction calculated by the line of sight direction calculation unit 53, and displays the information.

By this, in which direction the estimated user's eye position Ep with respect to the device is located can be calculated, and the information can be displayed at the position on the display area suitable for the line of sight direction.

Therefore, more appropriate display can be achieved in the electronic device attached to the body.

Additionally, the wrist terminal 1 further includes the triaxial acceleration sensor 12a and the posture position detection unit 52.

The triaxial acceleration sensor 12a detects the acceleration rate.

The posture position detection unit 52 detects the posture of the device and the relative position with respect to the visual point.

The eye position estimation unit 51 estimates the user's eye position Ep based on the detection result of the triaxial acceleration sensor 12a.

The line of sight direction calculation unit 53 calculates the line of sight direction with respect to the device based on the eye position Ep, the posture of the device, and the relative position with respect to the visual point.

By this, the user's eye position Ep is estimated from the user's movement, and various kinds of display are executed on the display area of the user's line of sight direction in accordance with the visual point, the posture of the wrist terminal 1, and the relative position with respect to the visual point.

Therefore, more appropriate display can be achieved in the electronic device attached to the body.

### Second Embodiment

Next, a second embodiment of the present invention will be described.

A wrist terminal 1 according to the present embodiment includes an imaging unit 22, an eye position estimation unit 51, and a line of sight direction calculation unit 53 having configurations different from a first embodiment. Note that the wrist terminal 1 according to the present embodiment does not include a posture position detection unit 52.

Therefore, the imaging unit 22, eye position estimation unit 51, and line of sight direction calculation unit 53 which are the sections different from the first embodiment will be mainly described.

According to the present embodiment, the wrist terminal 1 includes a plurality of imaging units 22. More specifically, the imaging units 22 are arranged at intervals in a plurality of places (e.g., three places) in a longitudinal direction in a periphery of a display area in a display panel 14 of the wrist terminal 1. With this configuration, in the case where the display panel 14 is circularly attached, an entire circumference of the wrist terminal 1 can be imaged by the plurality of imaging units 22.

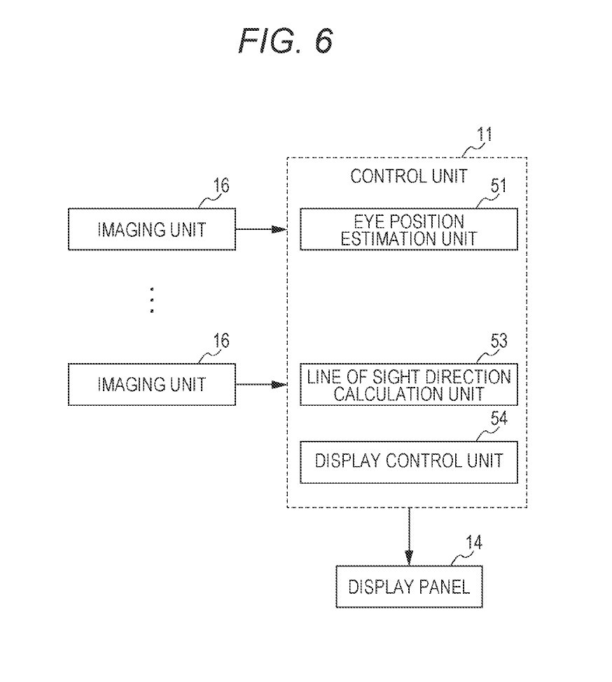

FIG. 6 is a functional block diagram of the wrist terminal 1 according to the second embodiment.

In FIG. 6, a configuration of a display control unit 54 is same as the case of the first embodiment in FIG. 2.

The eye position estimation unit 51 analyzes images imaged by the plurality of imaging units 22 and detects an eye position on a user's face. Further, the eye position estimation unit 51 estimates a user's eye position Ep based on the detected eye position in a field angle of the imaged image. At this point, the eye position estimation unit 51 estimates the user's eye position Ep by calculating a distance between the wrist terminal 1 and a user's visual point based on sizes of the imaged face and eye. Further, in the case where the user's eye is imaged by the plurality of imaging units 22, the eye position estimation unit 51 estimates the user's eye position based on overlapped field angles in the plurality of imaging units 22.

The line of sight direction calculation unit 53 calculates a display center position Cp based on the eye position Ep estimated by the eye position estimation unit 51 and arrangement positions of the imaging units 22 whereby the user's eye is imaged. For example, in the case where the user's eye is imaged by the imaging units 22 in the center of the field angle, the line of sight direction calculation unit 53 sets, as the display center position Cp, a center portion in a width direction of the display area with respect to the arrangement positions of the imaging units 22. Further, in the case where the user's eye is imaged within the field angle by the two imaging units 22, the line of sight direction calculation unit 53 sets, as the display center position Cp, the center portion in the width direction of the display area with respect to a middle point of the arrangement positions of the two imaging units 22.

Meanwhile, the display control unit 54 may change orientation of the display in accordance with arrangement of both eyes of the user in the images imaged by the imaging units 22.

Next, operation will be described.

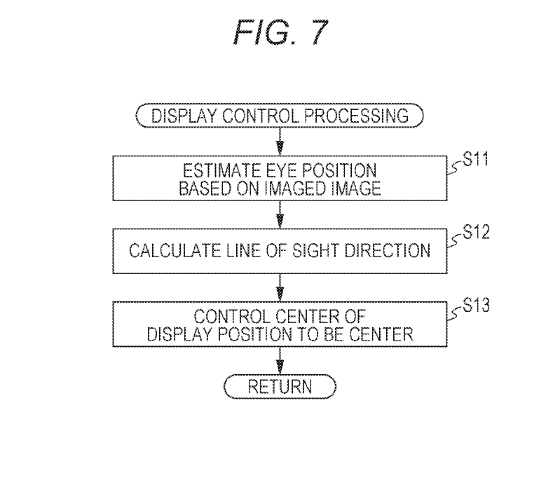

FIG. 7 is a flowchart illustrating an exemplary flow of display control processing according to the second embodiment.

The display control processing according to the present invention is started together with power activation of the wrist terminal 1, and repeatedly executed until a command to finish the processing is input.

When the display control processing is started, the eye position estimation unit 51 estimates the user's eye position Ep by detecting the user's eye position based on the images imaged by the imaging units 22 in step S11.

In step S12, the line of sight direction calculation unit 53 calculates the user's line of sight direction (display center position Cp) based on the line of sight direction estimated by the eye position estimation unit 51 and the arrangement positions of imaging units 22 whereby the user's eye is imaged.

In step S13, the display control unit 54 controls various kinds of display on the wrist terminal 1, centering the display center position Cp.

After step S13, the display control processing is repeated.

Thus, in the display control processing, the user's eye position Ep is estimated based on the image of the user's eye imaged by the imaging units 22, and the various kinds of display are executed on the display area located in the user's line of sight direction in accordance with the line of sight direction and the arrangement positions of the imaging units 22 whereby the user's eye is imaged.

By this, the reference position at the time of display can be uniquely defined and appropriate display can be achieved even in the case where the display area of the display panel 14 is circularly formed. Further, the reference position at the time of display can be easily defined based on the imaged image.

In other words, more appropriate display can be achieved in the electronic device attached to the body.

As described above, the wrist terminal 1 according to the present embodiment includes the imaging units 22.

The imaging units 22 image an object in the periphery of the device.

The eye position estimation unit 51 detects the eye position on a user's face based on the images imaged by the imaging units 22, thereby estimating the user's eye position Ep.

The line of sight direction calculation unit 53 calculates the line of sight direction with respect to the device based on the eye position Ep and the arrangement positions of the imaging units 22.

By this, the user's eye position Ep is estimated based on the images of the user's eye imaged by the imaging units 22, and the various kinds of display are executed on the display area located at the user's line of sight direction in accordance with the line of sight direction and the arrangement positions of the imaging units 22 whereby the user's eye is imaged. Further, the reference position at the time of display can be easily defined based on the imaged image.

Therefore, more appropriate display can be achieved in the electronic device attached to the body.

Note that the present invention is not limited to the above-described embodiments, and modifications, improvements, etc. may be included in the present invention within the scope of achieving the object of the present invention.

According to the above-described embodiments, the user's eye position Ep is estimated based on the detection result of the triaxial acceleration sensor 12a and the images imaged by the imaging units 22, but not limited thereto. More specifically, as long s the user's line of sight direction can be estimated, for example, other sensors, such as a gyro sensor, may be used to estimate the eye position Ep, or a transmitter configured to transmit a pilot signal to the user's eye position Ep (e.g., glasses, etc.) may be mounted and also the eye position Ep may be estimated by performing positioning by using the pilot signal received in the wrist terminal 1.

Also, according to the above-described embodiments, the wrist terminal has been described as an example of the electronic device to which the present invention is applied, but not limited thereto, the present invention can be applied to all types of terminals wearable by the user.

The above-described series of processing can be executed by hardware and also can be executed by software.

In other words, the functional configurations in FIGS. 2 and 6 are merely examples and not particularly limited thereto. More specifically, what at least required is that the wrist terminal 1 is provided with the functions that can execute the above-described series of processing as a whole, and what kind of functional block is to be used to implement the functions is not particularly limited to the examples illustrated in FIGS. 2 and 6.

Further, one functional block may be singularly formed of hardware, may be singularly formed of software, or may be formed by combining both.

In the case of executing the series of processing by the software, a program constituting the software is to be installed in a computer or the like from a network or a recording medium.

The computer may be a computer incorporated in dedicated hardware. Further, the computer may be, for example a computer, such as a general-purpose personal computer which can execute the various kinds of functions by installing various kinds of programs.

The recording medium including such programs is formed of not only a removable medium 31 in FIG. 1 distributed separately from the device main body in order to provide a user with a program but also a recording medium provided to the user in a state preliminarily incorporated in the device. The removable medium 31 includes, for example, a magnetism disk (including floppy disk), and optical disk, an optical magnetic disk, or the like. The optical disk includes, for example, a CD-ROM (Compact Disk-Read Only Memory), a DVD (Digital Versatile Disk), a Blu-ray (registered trademark) Disc (Blu-ray disk), and so on. The optical magnetic disk may include an MD (Mini-Disk) and the like. Further, the recording medium which is provided to the user in a state preliminarily incorporated in the device includes, for example, an ROM 16 or the like, illustrated in FIG. 1, in which the program is recorded.

Meanwhile, in the present specification, steps describing the program recorded in the recording medium obviously include processing sequentially executed in a time-series, and also includes processing not constantly executed in time-series but executed in parallel or individually.

While the embodiments of the present invention have been described above, the embodiments are merely the examples and not to limit the technical scope of the present invention. The present invention can have various kinds of embodiments, and further, various kinds of modifications including omission and replacement can be made within the scope without departing from the gist of the present invention. The embodiments and modifications thereof are included in the scope and gist of the invention recited in the present specification and so on, and to be included in the scope of claims and the scope of equivalents thereto.

What is claimed is:

1. An electronic device comprising:
a display unit including a display area to display information;
an eye position estimation unit configured to estimate at least one of eye positions of a user of the electronic device;
a line of sight direction calculation unit configured to calculate a line of sight direction of the user with respect to the electronic device based on the eye position estimated by the eye position estimation unit; and
a display control unit configured to change a display position of information on the display area of the display unit based on a change of the line of sight direction calculated by the line of sight direction calculation unit and display the information.

2. The electronic device according to claim 1, further comprising:
an acceleration rate detection unit configured to detect an acceleration rate; and
a posture position detection unit configured to detect a posture of the electronic device and a relative position of the electronic device with respect to the eye position, wherein
the eye position estimation unit estimates the user's eye position based on a detection result of the acceleration rate detection unit, and
the line of sight direction calculation unit calculates the line of sight direction with respect to the electronic device based on the eye position estimated by the eye position estimation unit and the posture and the relative position detected by the posture position detection unit.

3. The electronic device according to claim 1, further comprising an imaging unit configured to image a user of the electronic device, wherein
the eye position estimation unit estimates an eye position of the user by detecting an eye position on a face of the user based on the image imaged by the imaging unit, and
the line of sight direction calculation unit calculates the line of sight direction with respect to the device based on the eye position and an arrangement position of the imaging unit.

4. The electronic device according to claim 1, wherein the electronic device is a type of device to be worn around an arm, and when the device is worn around the arm, the display area is arranged all around or more than halfway around the arm of the user.

5. A display control method for an electronic device, comprising steps of:
estimating an eye position, in which at least one of eye positions of a user of the electronic device is estimated;
calculating a line of sight direction, in which a line of sight direction of the user with respect to the electronic device is calculated based on the eye position estimated by the eye position estimation unit; and
controlling display, in which a display position of information on a display area of a display unit is changed based on a change of the line of sight direction calculated by the line of sight direction calculation unit and the information is displayed.

6. A non-transitory computer-readable recording medium storing a program that causes a computer, the computer being configured to control an electronic device including a display unit having a display area to display information, to execute:
an eye position estimating function in which at least one of eye positions of a user of the electronic device is estimated;
a line of sight direction calculating function in which a line of sight direction of the user with respect to the electronic device is calculated based on the eye position estimated by the eye position estimation unit; and
a display control function in which a display position of information on the display area of the display unit is changed based on a change of the line of sight direction calculated by the line of sight direction calculation unit and the information is displayed.
